(19) United States
(12) Patent Application Publication
(10) Pub. No.: US 2007/0037001 A1
(43) Pub. Date: Feb. 15, 2007

(54) Water repellent composition for improving wood product dimensional stability

(76) Inventors: Xinhao Gao, East Amherst, NY (US); Jun Zhang, Getzville, NY (US); Christopher D. Schotz, Sanborn, NY (US)

Correspondence Address: HODGSON RUSS LLP, ONE M & T PLAZA, SUITE 2000, BUFFALO, NY, 14203-2391, US

(21) Appl. No.: 11/504,387

(22) Filed: Aug. 15, 2006

Related U.S. Application Data
(60) Provisional application No. 60/708,331, filed on Aug. 15, 2005.

(51) Int. Cl. B27K 3/15; C09K 21/00

(52) U.S. Cl. 428/541; 252/607

(57) ABSTRACT

Provided are compositions for improving the water-resistance and dimensional stability of wood and wood products. The compositions comprises wax and oil components, and can be applied as liquid compositions comprising little or no water. Also provided are methods for the application of the compositions to wood.

### CROSS-REFERENCE TO RELATED APPLICATIONS

This application claims priority to U.S. Provisional application No. 60/708,331, filed on Aug. 15, 2005, the disclosure of which is hereby incorporated by reference.

### BACKGROUND

The main components of wood are cellulose, hemicellulose and lignin. The cellulose and hemicellulose contain hydrophilic structures which are mainly hydroxyl groups. The hydroxyl groups have the ability to interact with water molecules to form hydrogen bonds. Wood is capable of absorbing as much as 100% of its weight in water which causes the wood to swell. Water loss through evaporation results in wood shrinking. This natural water absorption/evaporation process is non-uniform which creates internal stresses in the wood. These internal stresses cause the wood to check, split and warp when exposed in an outdoor environment.

Research activities to improve the dimensional stability of wood have increased over the years. Various approaches have been investigated such as reduction of water affinity of wood by means of heat treatment, chemical modification and enzymatic modification of the hydroxyl groups of cellulose or hemicellulose; or providing a barrier by external or internal coating to reduce water absorption of wood. The greatest amount of research has been in the area of cell wall bulking treatment. The deposition of bulking agents can be achieved by impregnating non-reactive bulking agents into the wood or by impregnating monomers into the wood followed by polymerization of the monomers within the wood. The bulking agents can be water soluble or insoluble, reactive or non-reactive with wood components. The bulking agents known to those skilled in the art include but not limited to polyethylene glycol (PEG), phenol, resorcinol, melamine and urea-formaldehydes, phenol furfural, furfuryl-analine and furfuryl alcohol and various vinyl resins such as polystyrene, polymethyl methacrylate, polyacrylonitrile, polyvinyl chloride with the help of wood swelling agent/agents.

There are currently three commercial processes available to afford dimensional stability to wood. They are acetylation, furfurylation and thermal treatment. The thermal treatment suffers from a mechanical strength loss of the wood. Acetylation requires a heating process following impregnation to start the acetylation reaction and a post treatment process is needed to remove residual acetic acid. The furfurylation of wood releases volatile organic compounds (VOCs) during the curing process. Those limitations and relative complexity of the processes limit their market potential.

There have been efforts to combine wax and oil to impart water repellency to wood. A water-based formulation containing a wax, and/or an oil, and surfactants, and treating the wood substrate with such formulation at a temperature at or above the melting point of wax is disclosed in U.S. Pat. No. 6,274,199. However, the above mentioned approach and other water based treatments can cause a wood substrate to swell during the treatment. The subsequent drying process may introduce stress, and thus checking and splitting.

Despite the efforts of many, there has been an unmet need to produce dimensional stabilization agents that are economical to treat wood, cellulose-based materials, and other materials to provide sufficient outdoor long term dimensional stability so significant reduction or even elimination of wood checking and splitting can be achieved. This need is solved by the subject matter disclosed herein.

### SUMMARY OF THE INVENTION

The present invention relates to a system for the treatment of wood and other cellulosic materials. The present invention provides compositions comprising one or more oils and one or more waxes. Wood and other cellulose materials treated with this system demonstrates significantly improved anti-swelling properties. The dimensional stability of the materials is thus improved.

Furthermore, it has been found that the addition of fatty acids and liquid polymers to the compositions can enhance their water-repellency and anti-checking efficacy. Thus, in additional embodiments, the composition additionally comprises a fatty acid and/or a liquid polymer.

The compositions of the present invention can behave synergistically in that application of the compositions to wood can often suppress the formation of checks upon long periods of exposure to high and/or fluctuating humidity conditions, such as outdoor conditions. This is surprising because oils or waxes, used alone, even in the substantial absence of water, generally cannot do this.

In another embodiment, the composition comprises, in addition to oil and wax components, one or more biocides, one or more pigments, one or more dyes and/or one or more fire retardants.

### BRIEF DESCRIPTION OF THE FIGS.

FIG. 1 depicts southern yellow pine control wafers after outdoor exposure for 6 months. Stain and checks were observed.

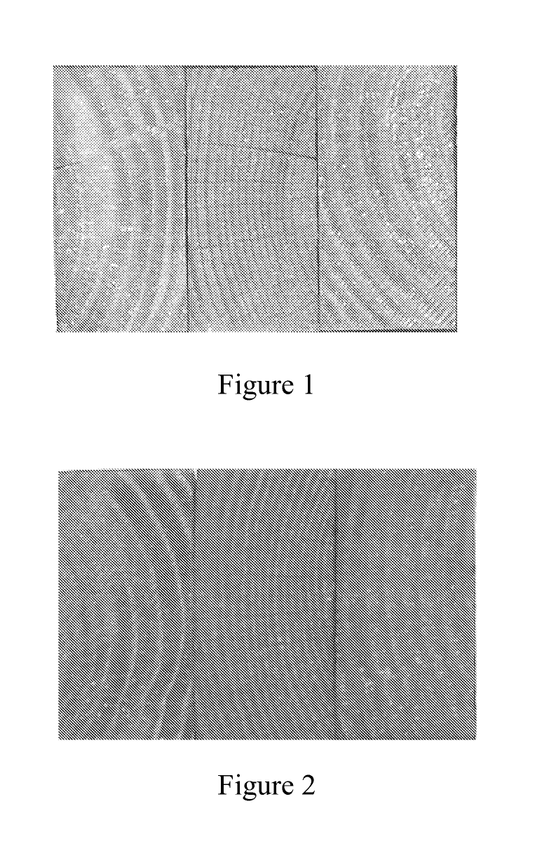

FIG. 2 depicts southern yellow pine wafers treated with linseed oil after outdoor exposure for 6 months. The panels were clean and large checks were eliminated, however micro-checks were still present.

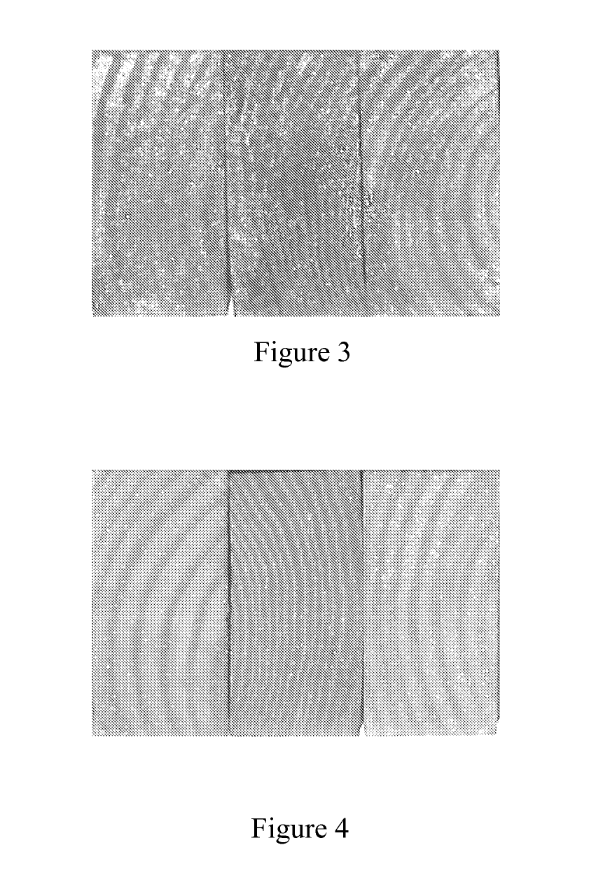

FIG. 3 depicts southern yellow pine wafers treated with a non-aqueous formulation (Example 3) after outdoor exposure for 6 months. The panels were very clean and check free.

FIG. 4 depicts southern yellow pine wafers treated with a non-aqueous formulation (Example 4) after outdoor exposure for 6 months. The panels were very clean and check free.

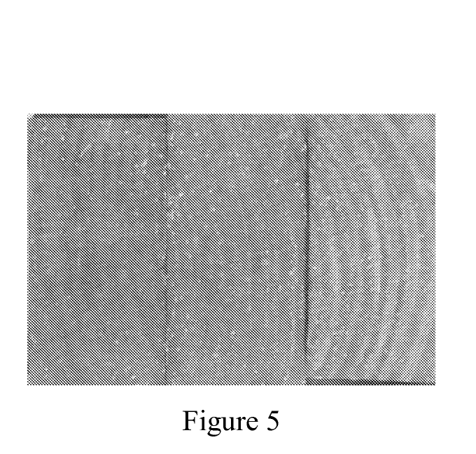

FIG. 5 depicts southern yellow pine wafers treated with paraffin wax after outdoor exposure for 6 months. Checks could be seen in the panels.

### DETAILED DESCRIPTION

Unless stated otherwise, such as in the examples, all amounts and numbers used in this specification are intended to be interpreted as modified by the term ‘about’. Likewise, all compounds or elements identified in this specification, unless stated otherwise, are intended to be non-limiting and representative of other compounds or elements generally considered by those skilled in the art as being within the same family of compounds or elements.

The term “wood” as used herein includes wood in its various forms, such as solid wood; wood composite materials, such as, for example, wood fiberboard, chipboard, particleboard; and products made from wood or wood composite materials, such as, for example, mill frames, decking, siding, siding cladding, roof shingles and utility poles. The term “cellulosic materials” as used herein includes paper, cotton and textile products which comprise cellulose fibers.

The oil/wax compositions of the present invention are preferably applied as a liquid. Such a liquid can generally be obtained by applying heat such that the composition is at a temperature of at least 30° C., and preferably at a temperature in the range of from about 30° C. to about 220° C., more preferably in the range of from about 40° C. to 200° C., still more preferably in the range of 50° C. to 180° C., and even more preferably in the range of from about 60° C. to 120° C. The oil and wax can be combined at room temperature, followed by heating, or heated and then combined, as desired. While it is preferable that the compositions of the present invention be applied to wood as a liquid, the composition can comprises additives, such as, for example, pigments and biocides, which can be particulate, such as in micronized form, etc.

The present invention can be applied to the wood or cellular materials by methods such as coating, dipping, brushing, spraying, or impregnation applications. Pressure impregnation is preferred. While it is convenient to apply the wax and oil as a wax/oil mixture, if desired, the wax and oil can be applied to the wood sequentially, in either order.

Without desiring to be bound by theory, it is thought that the compositions of the present invention have the ability to form a water repellent film to reduce the water adsorption and evaporation rates in a substrate. The subsequent reduction in the moisture gradient between outer regions of wood near the wood surface and internal regions of wood near the center of the wood substrate results in a reduction in internal stress and thus an increase in the substrate's dimensional stability. The inventive compositions are also thought to add bulk to the cell walls of the treated wood. Bulked cell walls generally resist deformation, and water absorption is generally decreased due to this effect as well.

Wax is widely used to provide water repellency and dimensional stability, however sufficient performance cannot be obtained by using wax alone. Oil treatments have been used to dry wood and provide a degree of water repellency and dimensional stability. However, only limited water repellency and dimensional stability has generally been obtained when oils or waxes are used alone.

The present invention provides a composition and process which provides a wood surface having reduced vulnerability to checking after extended exposure to outdoor conditions. This is particularly surprising in that oils or waxes used alone do not have such efficacy, even in the substantial absence of water (see Examples 1 and 2). The process of the present invention does not require the removal of water from the treated wood substrate during treatment, i.e., no subsequent volatile evaporation and thus the stresses as a result of the treatment are reduced or eliminated. Post treatment drying in a controlled environment, such as that generally required for a water based treatment, is not necessary with the present inventive process, thus simplifying the dimensional stabilization process and saving time.

It is believed that water enters wood by mass flow or diffusion of water vapor into the cell lumens and diffusion from there into the cell wall, or by diffusion of bound water entirely within the cell wall. Mass flow followed by diffusion into the cell wall is a much more rapid process than vapor phase or bound water diffusion. When the composition of the present invention is used in a full cell wood treatment, void space in the wood is occupied by the composition. Without desiring to be bound by theory, it is believed that mass flow and water vapor diffusion into the cell lumens is minimized. A second route for water entry is by diffusion of bound water within the cell wall. As the cell wall diffusion is slower than the mass flow diffusion, the rate of absorption and water penetration into the wood are greatly reduced.

Wood is hydrophilic, and it generally swells and shrinks due to variations in environmental humidity. In the case of wood treated with the present invention, the rate of swelling and shrinkage is reduced due to the elimination of water flow. The reduced rate of swelling and shrinking gives a reduced degree of stress, and thus a reduction of checking and splitting, i.e., essentially dimensionally stable.

The oil that can be used for this invention includes drying oils, non drying oils, low boiling oils and high boiling oils. They can be synthetic or harvested from natural origin such as vegetables and animals. Suitable oils include, but not limited to, linseed oil, tung oil, castor oil, soybean oil, corn oil, olive oil, peanut oil, rapeseed oil, safflower oil, cotton seed oil, sunflower oil, sesame seed oil, rice germ oil, palm oil, coconut oil, fish oil, whale oil and tall oil. The oils of petroleum origin such as aliphatic petroleum distillates, aromatic kerosene extracts and mineral oil can also be used.

When drying oils are used, oxidation catalysts such as naphthenates, tallates, dodeconates and octoates of cobalt, manganese, lead, zirconium, calcium, barium, zinc, cerium, cerium/lanthanum, iron, neodymium, bismuth and vanadium can be used to accelerate drying. Further, non-conventional oxidizing agents such as aluminum alkoxides can be used instead or in addition to the above. The complex amines such as 1,10,phenanthrolene and 2,2,dipyridyl can be added to conventional metal driers as synergists. The use of drying oils is a preferred embodiment because such oils generally do not give a treated product having oily or sticky surfaces, and thus the appearance of the wood is improved.

While oil alone is generally easily removed by water and can leave a treated wood product greasy or sticky, it has been found that the inclusion of wax overcomes these problems and can result in a treated product which retains the oil for long term performance and has surfaces which are relatively free of greasiness and stickiness.

The wax component suitable for the present invention is of petroleum, natural or synthetic origin. Examples of petroleum waxes are saturated hydrocarbon waxes such as paraffin wax, microcrystalline wax, slack wax and scale wax. Examples of natural waxes include carnauba wax, bees wax, montan wax, candelilla wax, ouricury wax, rice-bran wax, bayberry wax, peat wax, ceresin wax, Japan wax, Nopco wax and spermacetic wax. Examples of synthetic waxes which can be utilized in the present invention include certain polymethylene waxes, polyethylene waxes, polymerized α-olefin waxes, chemically modified waxes and silicone waxes as described more fully below. Alternatively, wax-like materials including halogenated oligomers and polymers, fatty acids, and metal salts of fatty acids such as, for example, the following: zinc stearate, magnesium stearate and aluminum stearate) can be used.

The saturated hydrocarbon waxes which can be used utilized in the present invention include those characterized by the general formula CₙH₂ₙ₊₂, wherein the molecular weight is in the range of from 250 to 30,000. The waxes generally are composed of normal alkanes, although isoalkanes and cycloalkanes, alkenyl compounds and alkynyl moieties may be present. Although the saturated hydrocarbon waxes are represented in the above formula as being composed of carbon and hydrogen only, it is contemplated that hydrocarbon waxes comprising minor amounts of other elements such as halogens, etc., are within the scope of the present invention. Thus, the term “saturated hydrocarbon” as used in the present invention is intended to include hydrocarbons as well as substituted hydrocarbons, wherein the extent of the substitution does not completely negate its utility in the present invention.

The saturated hydrocarbon waxes useful in the present invention also may also be characterized by their physical properties. For example, the waxes which are particularly useful in the compositions of the present invention generally have a melting point (ASTM D-87) of between about 38° C. and about 120° C.

The paraffin waxes are particularly preferred as the saturated hydrocarbon wax utilized in the compositions of the present invention. Paraffin waxes as used herein are petroleum waxes composed of about 40-90 weight percent of normal paraffins, and the remainder is C₁₈-C₃₆ isoalkanes and cycloalkanes. The oil content of paraffin wax is determined by the extent of the refining and finishing processes. Scale wax has 1-2% oil content, and slack wax has an oil content of more than 2%. Typical physical properties of paraffin waxes useful in the compositions of the present invention are a melting point in the range of 45° C. and about 75° C. and an average molecular weight in the range of from 350-420.

Polyethylene waxes include low molecular weight polyethylene having wax-like properties. Polyethylene waxes can be made by known techniques such as, for example, by high pressure polymerization, low pressure (Zeigler-type catalyst) polymerization, or controlled thermal degradation of high molecular weight polyethylene. Polymethylene waxes, also known in the art as Fischer-Tropsch waxes, can be produced by polymerizing carbon monoxide under high pressure and over iron catalysts. Low molecular weight synthetic waxes and wax byproducts melting between about 38° C. and 120° C. are contemplated as useful in this invention.

Hydrocarbon waxes of microcrystalline, polyethylene and Fischer-Tropsch can be chemically modified first by oxidation reaction. The oxidized wax can be further modified by saponification or esterification. Some polymers of high α-olefin (C>20) have wax like properties. The polymerization process yields highly branched materials with broad molecular weight distributions. The α-olefin waxes with melting points of about 55° C. to 80° C. and average molecular weights of about 2600-2800 are contemplated as useful in this invention.

Silicone wax can be obtained by hydrosilylation of an α-olefin, an unsaturated ester of higher fatty acid, an unsaturated ester of higher alcohol and a SiH bond-containing silicone compound. Silicone waxes with melting points in the range of from about 50° C. to 80° C. are contemplated as useful in this invention.

In one embodiment, the compositions also comprise fatty acids and/or liquid polymers for use thereof in treatment of cellulosic materials, more particularly wood, to provide improvement in water repellency and dimensional stability. The optional ingredients such as fatty acids and liquid polymers may be selected to augment performances further.

Both saturated and unsaturated fatty acids can be used in the present composition. Saturated fatty acids containing from about 4 to about 30 carbon atoms may generally be employed in the present invention. Suitable saturated fatty acids include, but are not limited to, the following: lauric acid, palmitic acid, stearic acid, behenic acid, 12-hydroxystearic acid, isostearic acid, and combinations thereof. The fatty acids with a long hydrocarbon alkane chain are typically solids at room temperature, and they can reduce or eliminate greasiness in the treated surface, as well as provide additional water repellency and help to retain the composition in treated substrate for long term performance. Unsaturated fatty acid can also be used in the composition. Unsaturated fatty acids suitable for use in the present invention are fatty acids containing about 4 to about 30 carbon atoms and at least one carbon-carbon double bond. Suitable fatty acids include, but are not limited to, the following: oleic acid, linoleic acid, linolenic acid, palmitoleic acid, arachidonic acid, and combinations thereof. Such fatty acids or fatty acid mixtures may be derived from natural fats and oils such as tung oil, safflower oil, coconut oil, corn oil, cottonseed oil, fish oil, whale oil, sunflower oil, sesame seed oil, linseed oil, castor oil, rice germ oil, and tallow.

Optionally, another component of the invention, a liquid polymer is one of the group consisting of liquid polybutadiene, polybutene and polyisobutylene. The liquid polybutadiene preferably has a number average molecular weight of 500-10,000, and more preferably 800-5,000. Departures from this range below 500 could result in weak and less water-proof coat film and above 10,000 could cause viscosity to be high enough to compromise efficacy. Specific examples of the liquid polybutadiene include low homopolymers of butadiene, as well as copolymers of butadiene and one or more of conjugated diolefins of 4-5 carbon atoms such as isoprene and piperylene, and low copolymers of butadiene.

Polybutene preferably has a number average molecular weight of 180-50,000, more preferably 450-1,500. Polybutene departing from this range below 180 could be a liquid of low viscosity, resulting in very weak film. Polybutene of greater than 50,000 in this molecular weight could be too viscous be easily blended with other components and also cause difficulties in to substrate penetration. The polybutene can be derived from mixtures of butene- 1, butene-2, isobutylene and butanes which may be processed by suitable known methods.

Polyisobutylene, another component according to the invention, can have a viscosity average molecular weight of preferably 350-50,000, more preferably 1,000-40,000. It is generally a viscous, semi-liquid vitreous material of relatively low fluidity. Polyisobutylenes of a viscosity average molecular weight exceeding 50,000 are generally semi-rubber which can be difficult to dissolve or blend with other components. The polyisobutylene to be used in the invention can be prepared by polymerization of isobutylenes available from a butane-butene fraction or from dehydration of tertiary butylalcohol or diacetone alcohol which may be refined by molecular sieve.

Optionally, rosin esters, polymerized rosins, polyterpene resins, styrenated terpenes and terpene phenolics can be selected to further enhance the performances of the formulations described in this invention.

Additional components which can also be included in the compositions of the present invention include moisture barrier polymers. Non-limiting examples include polyethylene, ethylene vinyl acetate copolymer (EVA), polyvinyl chloride, polyvinylidine and polyester.

The compositions of the present invention give exceptional anti-swelling efficiency (ASE) and water exclusion efficiency (WEE), and little or no checking and splitting in an outdoor environment. The ASE and WEE can be greater than 50%, and they are usually over 90%. FIGS. 3 and 4 demonstrate check-free performance of E4 wafers after outdoor exposure for 6 months.

A drawback of other processes and compositions for improving the dimensional stability of wood is the presence of volatiles, such as water, which generally must be removed by evaporation. The drying of volatiles from the wood can result in deformations and stresses which can cause checking.

The composition of the present invention has a “low water” content. By this, it is meant that water comprises less than about 25 weight percent of the composition which is applied to wood. In different embodiments, the composition comprises less than 20 wt %, 15 wt %, 10 wt %, 5 wt % and 1 wt % water. Less than 5 wt % water is considered to be “essentially water free.”

The compositions of the present invention may contain volatiles in the relatively small amounts above. Reasons for including volatiles include but are not limited to the solvation of biocide compounds (see below). Non-limiting examples of solvents used for dissolving azole and pyrethroid biocidal compounds include: dichloromethane, hexane, toluene, alcohols such as methanol, ethanol, and 2-propanol, glycols such as ethylene glycol and propylene glycol, ethers, esters, poly-glycols, poly-ethers, amides, methylene chloride, acetone, chloroform, N,N-dimethyl octanamide, N,N-dimethyl decanamide, N-methyl 2-pyrrolidone, and n-(n-octyl)-2-pyrrolidone.

In one embodiment, the compositions of the present invention are diluted in organic solvents. In this way, the retention of the wood can be controlled. Suitable solvents include the following:

Amines:

Diamylamine; Diethylamine; Diisopropylamine; Dimethylethylamine; Di-n-Butylamine; Mono-2-Ethylhexyamine; Monoamylamine; Mono-n-Butylaamine; Triaamylamine; Triethylamine; Tri-n-Butylamine; Dibutylaminoethanol; Diethylaminoethanol; Diethylaminoethoxyethanol; Diisopropylaminoethanol; Dimethylaminoethanol; Dimethylaminoethoxyethanol; Ethylaminoethanol; Isopropylaminoethanol; Methyldiethanolamine; Monomethylaminoethanol; Mono-n-Propylaminoethanol; n-Butylaminoethanol; n-Butyldiethanolamine; t-Butylaminoethanol; t-Butyldiethanolamine; Diethanolamine; Monoethanolamine; Triethanolamine; Diisopropanolamine; Monoisopropanolamine; Triisopropanolamine; Aminoethylethanolamine; Aminoethylpiperazine; Diethylenetriamine; Ethylenediamine; Piperazine 65%/Anhy.; Tetraethylenepentamine; Triethylenetetramine; 3-Methoxypropylamine; AMP® Regular/95; Cyclohexylamine; Morpholine; Neutrol TEO
   Glycols:
Diethylene Glycol; Dipropylene Glycol; Ethylene Glycol; Glycerine 96%, 99%, U.S.P.; Hexylene Glycol; Neol® Neopentyiglycol; Polyethylene Glycol; Polypropylene Glycol; Propylene Glycol Ind., U.S.P.; Tetraethylene Glycol; Triethylene Glycol; Tripropylene Glycol
   Ketones:
Acetone; Cyclohexanone; Diacetone; DIBK-Diisobutyl Ketone; Isophorone; MAK-Methyl Amyl Ketone; MEK-Methyl Ethyl Ketone; MIAK-Methyl Isoamyl Ketone; MIBK-Methyl Isobutyl Ketone; MPK-Methyl Propyl Ketone
   Esters:
Amyl Acetate; Dibasic Ester; Ethyl Acetate; 2 Ethyl Hexyl Acetate; Ethyl Propionate Exxate® Acetate Esters; Isobutyl Acetate; Isobutyl Isobuterate; Isopropyl Acetate; n-Butyl Acetate; n-Butyl Propionate; n-Pentyl Propionate; n-Propyl Acetate
   Alcohols:
Amyl Alcohol; Benzyl Alcohol; Cyclohexanol; Ethyl Alcohol-Denatured; 2-Ethyl Hexanol; Exxal 8® Isooctyl Alcohol; Exxal 10® Isodecyl Alcohol; Exxal 13® Tridecyl Alcohol; Furfuryl Alcohol; Isobutyl Alcohol; Isopropyl Alcohol 99% Anhy; Methanol; Methyl Amyl Alcohol (MIBC); n-Butyl Alcohol; n-Propyl Alcohol; Neodol® Linear Alcohol; Secondary Butyl Alcohol; Tertiary Butyl Alcohol; Tetrahydrofurfuryl Alcohol; Texanol Ester Alcohol®; UCAR Filmer IBT®
   Halogenated Carriers:
Methylene Chloride; Monochlorobenzene; Orthodichlorobenzene; Perchloroethylene; Trichloroethylene; Vertrel® Hydrofluorocarbon
   Aliphatic Carriers:
Heptane; Hexane; Kerosene; Lacquer Diluent; Mineral Seal Oil; Mineral Spirits; n-Pentane; OMS-Odorless Mineral Spirits; Rubber Solvent; 140 Solvent; 360 Solvent; Textile Spirits®; VM&P
   Aromatic Carriers:
Aromatic 100; Aromatic 150; Aromatic 200; Heavy Aromatic Solvent; Panasol®; Toluene; Xylene
   Terpene Carriers:
Alpha-Pinene, Wood; Dipentene 122®; D-Limonene; Herco® Pine Oil; Solvenol®; Steam
Distilled Turpentine; Terpineol®; Yarmor® 302,302-W Pine Oil
   Other Carriers:
ketones, methylene chloride, mineral spirits, mineral oil, linseed oil, xylene, olive oil, vegetable oil, methoxypropyl acetate, Ethyl Acetate, n-Butyl Acetate, Isopropyl Alcohol, Castor oil, Arconate HP® Propylene Carbonate, #2 fuel oil, Cypar® Cycloparaffin Solvent; DMF—Dimethyl Formamide; Exxprint® Ink Oil/Solvent Formamide; Furfural; Isopar® Isoparaffin Solvent; MTBE—Methyl Tert Butyl Ether; NMP—N Methyl Pyrrolidone; Norpar® Normal Paraffin Solvent; Proglyde DMM®; Glycol Diether; THF—Tetrahydrofuran; Varsol® Aliphatic Solvent

The compositions of the present invention behave in a synergistic manner when applied to wood. For example, for a given retention (weight percent gain), waxes and oils individually are less effective at reducing checks than when they are used together. In examples 1-3, it is demonstrated that at 70 weight percent gain, oils or waxes when used alone do not suppress checking upon exposure to the environment, while a 50 wt % composition of the two does. In general, for a given retention, the use of oils and waxes alone results in more checks than the use of an oil/wax mixture. By “outdoor conditions,” it is meant that the wood is subjected to environmental exposure, i.e., unprotected from the elements.

A further advantage of the present composition is that surfactants are not required. In one embodiment, surfactants comprises less than 5 wt % of the composition. In other embodiments, surfactants comprise less than 2 or 1 wt % of the composition.

The weight ratio of wax to oil can be in the range of from 100:0.1 to 0.1:100. Preferred is a weight ratio in the range of from 10:1 to 1:10, and more preferred is a ratio in the range of from about 2:1 to 1:2. The fatty acid and liquid polymer components, if present, can independently comprise from 0.1 to 35 wt % of the composition, and preferably comprise from 15-30 wt %.

The composition can be applied by many methods. Regardless of application method, it is preferred that the retention in the treated product be in the range of from about 1 to 150 wt % gain, more preferably in the range of from 20 to 130 wt % gain, and, in other embodiments in the range of from 40-110 and 60-90 wt % gain.

The composition may also contain additives such as, for example, pigments, dyes, fire retardants, biocides, etc. Examples of pigments which can be added are uv stabilizers. Non-limiting examples of UV stabilizers include UV light absorbers such as complex substituted aromatic compounds, UV light stabilizers such as complex hindered tertiary amines, and anti-oxidants.

If desired, pigments can be included in the composition as pigment dispersions. The pigments which can be used in the compositions of the present invention include inorganic and organic pigments. Inorganic pigments include compounds of metals such as iron, zinc, titanium, lead, chromium, copper, cadmium, calcium, zirconium, cobalt, magnesium, aluminum, nickel, and other transition metals. Carbon black is also an inorganic pigment.

Some non-limiting examples of suitable inorganic pigments include: iron oxides, including red iron oxides, yellow iron oxides, black iron oxides and brown iron oxides; carbon black, iron hydroxide, graphite, black micaceous iron oxide; aluminum flake pigments, pearlescent pigments; calcium carbonate; calcium phosphate; calcium oxide; calcium hydroxide; bismuth oxide; bismuth hydroxide; bismuth carbonate; copper carbonate; copper hydroxide; basic copper carbonate; silicon oxide; zinc carbonate; barium carbonate; barium hydroxide; strontium carbonate; zinc oxide; zinc phosphate; zinc chromate; barium chromate; chrome oxide; titanium dioxide; zinc sulfide and antimony oxide, lead chrome, and cadmium pigments.

Preferred inorganic pigments are carbon black; graphite; iron oxides, including yellow, red, black and brown iron oxides; zinc oxide; titanium oxide and aluminum-based pigments, such as, for example Al₂O₃Al(OH)₃.

Non-limiting examples of organic pigments include Monoazo (arylide) pigments such as PY3, PY65, PY73, PY74, PY97 and PY98; Disazo (diarylide); Disazo condensation; Benzimidazolone; Beta Naphthol; Naphthol; metal-organic complexes; Isoindoline and Isoindolinone; Quinacridone; perylene; perinone; anthraquinone; diketo-pyrrolo pyrrole; dioxazine; triacrylcarbonium; the phthalocyanine pigments, such as cobalt phthalocyanine, copper phthalocyanine, copper semichloro- or monochlorophthalocyanine, copper phthalocyanine, metal-free phthalocyanine, copper polychlorophthalocyanine, etc.; organic azo compounds; organic nitro compounds; polycyclic compounds, such as phthalocyanine pigments, quinacridone pigments, perylene and perinone pigments; diketopyrrolopyrrole(DPP) pigments; thioindigo pigments; dioxazine pigments; quinophthalone pigments; triacrylcarbonium pigments, and Diaryl pyrrolopyroles, such as PR254.

The term “dispersion” is understood to mean droplets or particles in a liquid continuous phase. The dispersion can be stabilized by conventional dispersing agents known to those skilled in the art.

Non-limiting examples of fire retardants include phosphorus compounds such as ammonia phosphate, ammonia polyphosphate, guanidine phosphate and melamine phosphate, boron compounds such as zinc borate and boric acid, metal carbonates such as Huntite (3MgCO₃×CaCO₃) and Hydromagnesite (Mg₅(CO₃)₄(OH)₂×4H₂O), metal hydroxides such as aluminium trihydroxide and magnesium hydroxide, organic halogen compounds such as chlorinated paraffins and brominated compounds, and urea can also be included in this composition. The halogenated materials may be used alone or together with antimony compounds such as antimony trioxide or antimony pentoxide which are thought to act as synergists.

Examples of biocides include water soluble or water insoluble inorganic or organic fungicides, insecticides, moldicides, bactericides, algaecides, such as for example, azoles, quaternary ammonium compounds, borate compounds, fluoride compounds and combinations thereof.

Some non-limiting examples of water insoluble organic biocides are listed as follows.

Aliphatic Nitrogen Fungicides

butylamine; cymoxanil; dodicin; dodine; guazatine; iminoctadine
   Amide Fungicides
carpropamid; chloraniformethan; cyazofamid; cyflufenamid; diclocymet; ethaboxam; fenoxanil; flumetover; furametpyr; prochloraz; quinazamid; silthiofam; triforine
benalaxyl; benalaxyl-M; furalaxyl; metalaxyl; metalaxyl-M; pefurazoate; benzohydroxamic acid; tioxymid; trichlamide; zarilamid; zoxamide; cyclafuramid; furmecyclox dichlofluanid; tolylfluanid benthiavalicarb; iprovalicarb; benalaxyl; benalaxyl-M; boscalid; carboxin; fenhexamid; metalaxyl; metalaxyl-M; metsulfovax; ofurace; oxadixyl; oxycarboxin; pyracarbolid; thifluzamide; tiadinil; benodanil; flutolanil; mebenil; mepronil; salicylanilide; tecloftalam; fenfuram; furalaxyl; furcarbanil; methfuroxam; flusulfamide
   Antibiotic Fungicides
aureofungin; blasticidin-S; cycloheximide; griseofulvin; kasugamycin; natamycin; polyoxins; polyoxorim; streptomycin; validamycin; azoxystrobin; dimoxystrobin; fluoxastrobin; kresoxim-methyl; metominostrobin; orysastrobin; picoxystrobin; pyraclostrobin; trifloxystrobin
   Aromatic Fungicides
biphenyl; chlorodinitronaphthalene; chloroneb; chlorothalonil; cresol; dicloran; hexachlorobenzene; pentachlorophenol; quintozene; sodium pentachlorophenoxide; tecnazene
   Benzimidazole Fungicides
benomyl; carbendazim; chlorfenazole; cypendazole; debacarb; fuberidazole; mecarbinzid; rabenzazole; thiabendazole
   Benzimidazole Precursor Fungicides
furophanate; thiophanate; thiophanate-methyl
   Benzothiazole Fungicides
bentaluron; chlobenthiazone; TCMTB
   Bridged Diphenyl Fungicides
bithionol; dichlorophen; diphenylamine
   Carbamate Fungicides
benthiavalicarb; furophanate; iprovalicarb; propamocarb; thiophanate; thiophanate-methyl; benomyl; carbendazim; cypendazole; debacarb; mecarbinzid; diethofencarb
   Conazole Fungicides
climbazole; clotrimazole; imazalil; oxpoconazole; prochloraz; triflumizole; azaconazole; bromuconazole; cyproconazole; diclobutrazole; difenoconazole; diniconazole; diniconazole-M; epoxiconazole; etaconazole; fenbuconazole; fluquinconazole; flusilazole; flutriafol; furconazole; furconazole-cis; hexaconazole; imibenconazole; ipconazole; metconazole; myclobutanil; penconazole; propiconazole; prothioconazole; quinconazole; simeconazole; tebuconazole; tetraconazole; triadimefon; triadimenol; triticonazole; uniconazole; uniconazole-P
   Dicarboximide Fungicides
famoxadone; fluoroimide; chlozolinate; dichlozoline; iprodione; isovaledione; myclozolin; procymidone; vinclozolin; captafol; captan; ditalimfos; folpet; thiochlorfenphim
   Dinitrophenol Fungicides
binapacryl; dinobuton; dinocap; dinocap-4; dinocap-6; dinocton; dinopenton; dinosulfon; dinoterbon; DNOC
   Dithiocarbamate Fungicides
azithiram; carbamorph; cufraneb; cuprobam; disulfiram; ferbam; metam; nabam; tecoram; thiram; ziram; dazomet; etem; milneb; mancopper; mancozeb; maneb; metiram; polycarbamate; propineb; zineb
   Imidazole Fungicides
cyazofamid; fenamidone; fenapanil; glyodin; iprodione; isovaledione; pefurazoate; triazoxide
   Morpholine Fungicides
aldimorph; benzamorf; carbamorph; dimethomorph; dodemorph; fenpropimorph; flumorph; tridemorph
   Organophosphorus Fungicides
ampropylfos; ditalimfos; edifenphos; fosetyl; hexylthiofos; iprobenfos; phosdiphen; pyrazophos; tolclofos-methyl; triamiphos
   Oxathiin Fungicides
carboxin; oxycarboxin
   Oxazole Fungicides
chlozolinate; dichlozoline; drazoxolon; famoxadone; hymexazol; metazoxolon; myclozolin; oxadixyl; vinclozolin
   Pyridine Fungicides
boscalid; buthiobate; dipyrithione; fluazinam; pyridinitril; pyrifenox; pyroxychlor; pyroxyfur
   Pyrimidine Fungicides
bupirimate; cyprodinil; diflumetorim; dimethirimol; ethirimol; fenarimol; ferimzone; mepanipyrim; nuarimol; pyrimethanil; triarimol
   Pyrrole Fungicides
fenpiclonil; fludioxonil; fluoroimide
   Quinoline Fungicides
ethoxyquin; halacrinate; 8-hydroxyquinoline sulfate; quinacetol; quinoxyfen
   Quinone Fungicides
benquinox; chloranil; dichlone; dithianon
   Quinoxaline Fungicides
chinomethionat; chlorquinox; thioquinox
   Thiazole Fungicides
ethaboxam; etridiazole; metsulfovax; octhilinone; thiabendazole; thiadifluor; thifluzamide
   Thiocarbamate Fungicides
methasulfocarb; prothiocarb
   Thiophene Fungicides
ethaboxam; silthiofam
   Triazine Fungicides
anilazine
   Triazole Fungicides
bitertanol; fluotrimazole; triazbutil
   Urea Fungicides
bentaluron; pencycuron; quinazamid
   Other Fungicides
acibenzolar; acypetacs; allyl alcohol; benzalkonium chloride; benzamacril; bethoxazin; carvone; chloropicrin; DBCP; dehydroacetic acid; diclomezine; diethyl pyrocarbonate; fenaminosulf; fenitropan; fenpropidin; formaldehyde; furfural; hexachlorobutadiene; iodomethane; isoprothiolane; methyl bromide; methyl isothiocyanate; metrafenone; nitrostyrene; nitrothal-isopropyl; OCH; 2 phenylphenol; phthalide; piperalin; probenazole; proquinazid; pyroquilon; sodium orthophenylphenoxide; spiroxamine; sultropen; thicyofen; tricyclazole

Preferred insecticides which can be mixed with non-aqueous water repellent composition disclosed in the present invention are:

Antibiotic Insecticides

allosamidin; thuringiensin; spinosad; abamectin; doramectin; emamectin; eprinomectin; ivermectin; selamectin; milbemectin; milbemycin oxime; moxidectin
   Botanical Insecticides
anabasine; azadirachtin; d-limonene; nicotine; pyrethrins cinerins; cinerin I; cinerin II; jasmolin I; jasmolin II; pyrethrin I; pyrethrin II; quassia; rotenone; ryania sabadilla
   Carbamate Insecticides
bendiocarb; carbaryl; benfuracarb; carbofuran; carbosulfan; decarbofuran; furathiocarb; dimetan; dimetilan; hyquincarb; pirimicarb; alanycarb; aldicarb; aldoxycarb; butocarboxim; butoxycarboxim; methomyl; nitrilacarb; oxamyl; tazimcarb; thiocarboxime; thiodicarb; thiofanox; allyxycarb; aminocarb; bufencarb; butacarb; carbanolate; cloethocarb; dicresyl; dioxacarb; EMPC; ethiofencarb; fenethacarb; fenobucarb; isoprocarb; methiocarb; metolcarb; mexacarbate; promacyl; promecarb; propoxur; trimethacarb; XMC; xylylcarb
   Dinitrophenol Insecticides
dinex; dinoprop; dinosam; DNOC; cryolite; sodium hexafluorosilicate; sulfluramid
   Formamidine Insecticides
amitraz; chlordimeform; formetanate; formparanate
   Fumigant Insecticides
acrylonitrile; carbon disulfide; carbon tetrachloride; chloroform ; chloropicrin; para-dichlorobenzene; 1,2-dichloropropane; ethyl formate; ethylene dibromide; ethylene dichloride; ethylene oxide; hydrogen cyanide; iodomethane; methyl bromide; methylchloroform; methylene chloride; naphthalene; phosphine; sulfuryl fluoride; tetrachloroethane
   Insect Growth Regulators
bistrifluron; buprofezin; chlorfluazuron; cyromazine; diflubenzuron; flucycloxuron; flufenoxuron; hexaflumuron; lufenuron; novaluron; noviflumuron; penfluron; teflubenzuron; triflumuron; epofenonane; fenoxycarb; hydroprene; kinoprene; methoprene; pyriproxyfen; triprene; juvenile hormone I; juvenile hormone II; juvenile hormone III; chromafenozide; halofenozide; methoxyfenozide; tebufenozide; α-ecdysone; ecdysterone; diofenolan; precocene I; precocene II; precocene III; dicyclanil
   Nereistoxin Analogue Insecticides
bensultap; cartap; thiocyclam; thiosultap; flonicamid; clothianidin; dinotefuran; imidacloprid; thiamethoxam; nitenpyram nithiazine; acetamiprid; imidacloprid; nitenpyram; thiacloprid
   Organochlorine Insecticides
bromo-DDT; camphechlor; DDT; pp-DDT; ethyl-DDD; HCH; gamma-HCH; lindane; methoxychlor; pentachlorophenol; TDE; aldrin; bromocyclen; chlorbicyclen; chlordane; chlordecone; dieldrin; dilor; endosulfan; endrin; HEOD; heptachlor; HHDN; isobenzan; isodrin; kelevan; mirex
   Organophosphorus Insecticides
bromfenvinfos; chlorfenvinphos; crotoxyphos; dichlorvos; dicrotophos; dimethylvinphos; fospirate; heptenophos; methocrotophos; mevinphos; monocrotophos; naled; naftalofos; phosphamidon; propaphos; schradan; TEPP; tetrachlorvinphos; dioxabenzofos fosmethilan phenthoate; acethion; arniton; cadusafos; chlorethoxyfos; chlonnephos; demephion; demephion-O; demephion-S; demeton; demeton-O; demeton-S; demeton-methyl; demeton-O-methyl; demeton-S-methyl; demeton-S-methylsulphon; disulfoton ethion; ethoprophos; IPSP; isothioate; malathion; methacrifos; oxydemeton-methyl; oxydeprofos; oxydisulfoton phorate; sulfotep; terbufos; thiometon amidithion; cyanthoate; dimethoate; ethoate-methyl; formothion mecarbam; omethoate; prothoate; sophamide; vamidothion chlorphoxim; phoxim; phoxim-methyl azamethiphos; coumaphos; coumithoate; dioxathion; endothion; menazon; morphothion; phosalone; pyraclofos; pyridaphenthion; quinothion; dithicrofos; thicrofos; azinphos-ethyl; azinphos-methyl; dialifos; phosmet; isoxathion; zolaprofos; chlorprazophos; pyrazophos; chlorpyrifos; chlorpyrifos-methyl; butathiofos; diazinon; etrimfos; lirimfos; pirimiphos-ethyl; pirimiphos-methyl; primidophos; pyrimitate; tebupirimfos; quinalphos; quinalphos-methyl; athidathion; lythidathion; methidathion; prothidathion; isazofos; triazophos; azothoate; bromophos; bromophos-ethyl; carbophenothion; chlorthiophos; cyanophos; cythioate; dicapthon; dichlofenthion; etaphos; famphur; fenchlorphos; fenitrothion; fensulfothion; fenthion; fenthion-ethyl; heterophos; jodfenphos; mesulfenfos; parathion; parathion-methyl; phenkapton; phosnichlor; profenofos; prothiofos; sulprofos; temephos; trichlormetaphos-3; trifenofos; butonate; trichlorfon; mecarphon; fonofos; trichloronat; cyanofenphos; EPN; leptophos; crufomate; fenamiphos; fosthietan; mephosfolan; phosfolan; pirimetaphos; acephate; isocarbophos; isofenphos; methamidophos; propetamphos; dimefox; mazidox; mipafox
   Oxadiazine Insecticides
indoxacarb
   Phthaliniide Insecticides
dialifos; phosmet; tetramethrin
   Pyrazole Insecticides
acetoprole; ethiprole; fipronil; tebufenpyrad; tolfenpyrad; vaniliprole
   Pyrethroid Insecticides
acrinathrin; allethrin; bioallethrin; barthrin; bifenthrin; bioethanomethrin; cyclethrin; cycloprothrin; cyfluthrin; beta-cyfluthrin; cyhalothrin; gamma-cyhalothrin; lambda-cyhalothrin; cypermethrin; alpha-cypermethrin; beta-cypermethrin; theta-cypermethrin; zeta-cypermethrin; cyphenothrin; deltamethrin; dimefluthrin; dimethrin; empenthrin; fenfluthrin; fenpirithrin; fenpropathrin; fenvalerate; esfenvalerate; flucythrinate; fluvalinate; taufluvalinate; furethrin; imiprothrin; metofluthrin; pennethrin; biopermethrin; transpermethrin; phenothrin; prallethrin; profluthrin; pyresmethrin; resmethrin; bioresmethrin; cismethrin; tefluthrin; terallethrin; tetramethrin; tralomethrin; transfluthrin; etofenprox; flufenprox; halfenprox; protrifenbute; silafluofen
   Pyrimidinamine Insecticides
flufenerim; pyrimidifen
   Pyrrole Insecticides
chlorfenapyr
   Tetronic Acid Insecticides
spiromesifen
   Thiourea Insecticides
diafenthiuron
   Urea Insecticides
flucofuron; sulcofuron
   Other Insecticides
closantel; crotamiton; EXD; fenazaflor; fenoxacrim; hydramethylnon; isoprothiolane; malonoben; metoxadiazone; nifluridide; pyridaben; pyridalyl; rafoxanide; triarathene;
triazamate
   Preferred Bactericides Include:
bronopol; cresol; dichlorophen; dipyrithione; dodicin; fenaminosulf; formaldehyde; hydrargaphen; 8-hydroxyquinoline sulfate; kasugamycin; nitrapyrin; octhilinone; oxolinic acid; oxytetracycline probenazole; streptomycin tecloftalam thiomersal

Non-biocidal products such as colorants, UV inhibitors, plasticizers, compatibility enhancing agents and the like may also be added to the system disclosed herein to further enhance the performance of the system or the appearance and performance of the resulting treated products.

Other biocides known to those skilled in the art that can optionally used with the present invention include insecticides, mold inhibitors, algaecides, bactericides and the like.

While it is preferred that the wax, oil, and fatty acid and/or liquid polymer component be applied as a liquid, the composition may comprise additives, such as, for example, pigments, biocides, fire retardants, etc., which may be in particulate form, such as, for example, micronized. The full penetration of the water repellent composition, including particulate additives, into the wood's or other cellulose-based material's cellular structure, can depend upon the particle sizes in the particulate component.

The primary entry and movement of fluids through wood tissue occurs primarily through the tracheids and border pits. Tracheids very roughly have a diameter of about thirty microns. Fluids are transferred between wood cells by means of border pits. Particulate components used in the composition disclosed herein having a particle size in excess of the tracheids diameter may be filtered by the surface of the wood and thus may not be uniformly distributed within the cell and cell wall.

The overall diameter of the border pit chambers typically varies from a several microns up to thirty microns, while the diameter of the pit openings (via the microfibrils) typically varies from several hundredths of a micron to several microns.

The particle size of particulate component used in the composition disclosed herein typically does not exceed 30 microns or it tends to be filtered by the surface of the wood thus not attaining a desired penetration and fluid flow through the wood tissue. In one embodiment particle size of particulate component used in the composition disclosed herein can be between 0.001-10 microns. Particle size of the particulate component used in the composition disclosed herein can also be between 0.001-1.0 microns to provide a more uniform penetration of the chemicals into the wood tissue.

The swelling and water absorption were tested according to AWPA Standard E4-03 “Standard Method of Testing Water Repellency of Pressure Treated Wood”. The treating fluids of various formulations were used to treat southern yellow pine E4 wafers (size: 6.4×mm×25 mm×50 mm, or 0.25 in.×1 in.×2 in., in the longitudinal, radial and tangential directions, respectively). The treating fluids were vacuum impregnated into the E4 wafers using a vacuum of not less than 25 inches of Hg followed by submersion of the wafers at atmospheric pressure. The chemical retention of the wafers was calculated from the solution pickups. The treated wafers were allowed to air cool and condition in an exhaust hood for 2 weeks.

The AWPA E-4-78 water immersion test was used to determine the water repellency of the treated wafers. The treated E4 wafers and untreated controls were immersed in water for 30 minutes and the tangential swelling of the wafers and the weight gain were measured using a caliper and a balance specified in the standard. The percentage swell is the tangential length percentage increase after soaking in water for 30 minutes. It can be calculated using an average of three wafers from different parent boards. The water immersion test provides data for the calculation of the anti-swelling efficiency and the water exclusion efficiency according to the following equations:

Anti-swelling efficiency (ASE) is defined as the percentage swell reduced by the treatment versus the untreated controls.

$$ASE ( \% ) = \frac{\% Swell of Untreated Control - \% Swell of Treated Sample}{\% Swell of Untreated Control} \times 100$$

Water exclusion efficiency (WEE) is defined as the water absorption reduction by the treatment in percentage in comparison to untreated controls.

$$WEE ( \% ) = \frac{\% Wt Gain of UntreatedControl - \% Wt Gain of Treated Sample}{\% Wt Gain of UntreatedControl} \times 100$$

In general, higher ASE and WEE values correspond to more effective dimensional stabilization of wood.

The application of the composition can be dipping, soaking, brushing, spraying, or any other means known to those skilled in the art. In a preferred embodiment, especially when micronized additives are used, vacuum and/or pressure techniques are used to impregnate the wood in accord with this invention including the standard processes, such as the “Empty Cell” process, the “Modified Full Cell” process and the “Full Cell” process, and any other vacuum and/or pressure processes which are known to those skilled in the art.

The standard processes are defined as described in AWPA Standard C1-03 “All Timber Products-Preservative Treatment by Pressure Processes”. In the “Empty Cell” process, prior to the introduction of present composition, materials are subjected to atmospheric air pressure (Lowry) or to higher air pressure (Rueping) of the necessary intensity and duration. In the “Modified Full Cell” process, prior to the introduction of present composition, materials are subjected to a vacuum of less than 77 kPa (22 inch Hg, sea level equivalent). A final vacuum of less than 77 kPa (22 inch Hg, sea level equivalent) shall be used. In the “Full Cell” process, prior to the introduction of present composition or during any period of condition prior to treatment, materials are subjected to a vacuum of less than 77 kPa (22 inch Hg). A final vacuum of less than 77 kPa (22 inch Hg) is used.

The following examples are provided to further describe certain embodiments of the disclosure but are in no way limiting the scope of disclosure. All examples contain water in an amount of less than 1 wt percent and are treated to about 70 wt % retention.

### EXAMPLE 1

### Comparative Example

(Wax Only)

Paraffin wax melted at 70° C. was used to treat 0.25″×1″×2″ samples of southern pine sapwood E4 wafers, using an initial vacuum of 28″ Hg for 15 minutes, followed by submerging the E4 wafers in the above treating fluid under atmospheric condition for 20 minutes. The resulting treated wood was weighed and found to have increased its weight by about 70%. The samples were cooled down to room temperature and tested for Water Repellency according to AWPA Standard E4-03. The anti-swelling efficiency (ASE) and water exclusion efficiency (WEE) obtained were found to be about 96% and about 97% respectively. FIG. 5 is a photograph of the weathered wafers treated with paraffin wax as described above. Checks could be seen in the wafers.

### EXAMPLE 2

### Comparative Example

(Oil Only)

Linseed oil was used to treat southern pine sapwood E4 wafers, using an initial vacuum of 28″ Hg for 15 minutes, followed by submerging the E4 wafers in the above treating fluid under atmospheric condition for 20 minutes. The treatment was performed at 70 ° C. to 70 wt % retention. The treated samples were tested for Water Repellency according to AWPA Standard E4-03. The anti-swelling efficiency (ASE) and water exclusion efficiency (WEE) obtained was found to be about 95% and about 95% respectively. FIG. 1 is a photograph of the weathered untreated control after six months exposure which shows checks and staining of the wafers. FIG. 2 is a photograph of the weathered wafers treated with linseed oil described above. The weathered wafers showed checking and staining after 6 months of outdoor exposure.

### EXAMPLE 3

(Wax/Oil)

A mixture of 50% paraffin wax/50% linseed oil was made with solid paraffin wax and linseed oil. The mixture was mechanically stirred at 70° C. to melt paraffin wax and further mixing for 5 minutes to achieve a homogeneous fluid. The fluid was then used to treat southern pine sapwood E4 wafers using an initial vacuum of 28″ Hg for 15 minutes, followed by submerging the E4 wafers in the above treating fluid under atmospheric condition for 20 minutes. The samples were tested for Water Repellency according to AWPA Standard E4-03. The anti-swelling efficiency (ASE) and water exclusion efficiency (WEE) obtained was found to be about 97% and about 96% respectively. FIG. 3 is a photograph of the weathered wafers treated with the above composition. The weathered wafers showed no checking or staining after 6 months of outdoor exposure. The synergistic effect of paraffin wax and linseed oil on the checking resistance was demonstrated.

### EXAMPLE 4

(Wax/Oil/Fatty Acid/Liquid Polymer)

A mixture of 20% paraffin wax/20% linseed oil/20% mineral oil/20% stearic acid/20% polybutene was made with solid paraffin wax, stearic acid, linseed oil, mineral oil and polybutene. The mixture was mechanically stirred at 70° C. to melt paraffin wax and stearic acid and further mixing for 5 minutes to achieve a homogeneous fluid. The fluid was then used to treat southern pine sapwood E4 wafers using an initial vacuum of 28″ Hg for 15 minutes, followed by submerging the E4 wafers in the above treating fluid under atmospheric condition for 20 minutes. The samples were tested for Water Repellency according to AWPA Standard E4-03. The anti-swelling efficiency (ASE) and water exclusion efficiency (WEE) obtained was found to be about 95% and about 96% respectively. FIG. 4 is a photograph of the weathered wafers treated with the above composition. Weathered wafers showed no checking or staining after 6 months of outdoor exposure.

### EXAMPLE 5

(Wax/Oil/Fatty Acid/Liquid Polymer)

A mixture of 10% paraffin wax/10% linseed oil/10% mineral oil/60% stearic acid/10% polybutene was made with solid paraffin wax, stearic acid, linseed oil, mineral oil and polybutene. The mixture was mechanically stirred at 70° C. to melt paraffin wax and stearic acid and further mixing for 5 minutes to achieve a homogeneous fluid. The fluid was then used to treat southern pine sapwood E4 wafers using an initial vacuum of 28″ Hg for 15 minutes, followed by submerging the E4 wafers in the above treating fluid under atmospheric condition for 20 minutes. The samples were tested for Water Repellency according to AWPA Standard E4-03. The anti-swelling efficiency (ASE) and water exclusion efficiency (WEE) obtained was found to be about 94% and about 94% respectively. Weathered wafers showed no checking or staining after 6 months of outdoor exposure.

### EXAMPLE 6

(Wax/Oil/Fatty Acid/Liquid Polymer)

A mixture of 10% paraffin wax/10% linseed oil/60% mineral oil/10% stearic acid/10% polybutene was made with solid paraffin wax, stearic acid, linseed oil, mineral oil and polybutene. The mixture was mechanically stirred at 70° C. to melt paraffin wax and stearic acid and further mixing for 5 minutes to achieve a homogeneous fluid. The fluid was then used to treat southern pine sapwood E4 wafers using an initial vacuum of 28″ Hg for 15 minutes, followed by submerging the E4 wafers in the above treating fluid under atmospheric condition for 20 minutes. The samples were tested for Water Repellency according to AWPA Standard E4-03. The anti-swelling efficiency (ASE) and water exclusion efficiency (WEE) obtained was found to be about 98% and about 95% respectively.

### EXAMPLE 7

(Wax/Oil/Fatty Acid/Liquid Polymer)

A mixture of 25% paraffin wax/25% linseed oil/25% stearic acid/25% polybutene was made with solid paraffin wax, stearic acid, linseed oil and polybutene. The mixture was mechanically stirred at 70° C. to melt paraffin wax and stearic acid and further mixing for 5 minutes to achieve a homogeneous fluid. The fluid was then used to treat southern pine sapwood E4 wafers using an initial vacuum of 28″ Hg for 15 minutes, followed by submerging the E4 wafers in the above treating fluid under atmospheric condition for 20 minutes. The samples were tested for Water Repellency according to AWPA Standard E4-03. The anti-swelling efficiency (ASE) and water exclusion efficiency (WEE) obtained was found to be about 96% and about 95% respectively.

### EXAMPLE 8

(Wax/Oil/Liquid Polymer)

A mixture of 25% paraffin wax/25% linseed oil/25% mineral oil/25% polybutene was made with solid paraffin wax, linseed oil, mineral oil and polybutene. The mixture was mechanically stirred at 70° C. to melt paraffin wax and stearic acid and further mixing for 5 minutes to achieve a homogeneous fluid. The fluid was then used to treat southern pine sapwood E4 wafers using an initial vacuum of 28″ Hg for 15 minutes, followed by submerging the E4 wafers in the above treating fluid under atmospheric condition for 20 minutes. The samples were tested for Water Repellency according to AWPA Standard E4-03. The anti-swelling efficiency (ASE) and water exclusion efficiency (WEE) obtained was found to be about 96% and about 95% respectively.

### EXAMPLE 9

(Wax/Oil/Fatty Acid)

A mixture of 25% paraffin wax/25% linseed oil/25% mineral oil/25% stearic acid was made with solid paraffin wax, linseed oil, mineral oil and stearic acid. The mixture was mechanically stirred at 70° C. to melt paraffin wax and stearic acid and further mixing for 5 minutes to achieve a homogeneous fluid. The fluid was then used to treat southern pine sapwood E4 wafers using an initial vacuum of 28″ Hg for 15 minutes, followed by submerging the E4 wafers in the above treating fluid under atmospheric condition for 20 minutes. The samples were tested for Water Repellency according to AWPA Standard E4-03. The anti-swelling efficiency (ASE) and water exclusion efficiency (WEE) obtained was found to be about 96% and about 95% respectively.

### EXAMPLE 10

(Wax/Oil/Fatty Acid/Liquid Polymer)

A mixture of 20% paraffin wax/20% linseed oil/20% mineral oil/20% stearic acid/20% polybutene/0.1% copper 8-hydroxyquinoline was made with solid paraffin wax, stearic acid, linseed oil, mineral oil, polybutene and copper 8-hydroxyquinoline. The mixture was mechanically stirred at 70° C. to melt paraffin wax, stearic acid and to dissolve copper 8-hydroxyquinoline. A homogeneous fluid can be ensured with 5 minutes of further mixing. The fluid was then used to treat southern pine sapwood E4 wafers using an initial vacuum of 28″ Hg for 15 minutes, followed by submerging the E4 wafers in the above treating fluid under atmospheric condition for 20 minutes. The addition of copper 8-hydroxyquinoline provides biocidal protection to the wood substrate.

### EXAMPLE 11

(Wax/Oil/Fatty Acid/Liquid Polymer)

A mixture of 20% paraffin wax/20% linseed oil/20% mineral oil/20% stearic acid/20% polybutene/0.1% copper 8-hydroxyquinoline/0.5% pigment was made with solid paraffin wax, stearic acid, linseed oil, mineral oil, polybutene, oil based copper 8-hydroxyquinoline concentrate and oil based pigment dispersion. The mixture was mechanically stirred at 70° C. to melt paraffin wax, stearic acid and to dissolve copper 8-hydroxyquinoline. A homogeneous fluid can be ensured with 5 minutes of further mixing. The fluid was then used to treat southern pine sapwood E4 wafers using an initial vacuum of 28″ Hg for 15 minutes, followed by submerging the E4 wafers in the above treating fluid under atmospheric condition for 20 minutes. The treated wafers had uniform color. The addition of pigment dispersion provides long term UV protection to the wood substrate.

Although specific embodiments have been described herein, those skilled in the art will recognize that routine modifications can be made without departing from the spirit of the invention.

We claim:

1. A composition for imparting dimensional stability to wood or a wood product substrate, said composition comprising:
a) a wax;
b) an oil;
wherein the composition comprises less than 25 weight percent water.

2. A composition as in claim 1 wherein the composition comprises less than 10 weight percent water.

3. A composition as in claim 1 wherein the composition comprises less than 5 weight percent water.

4. A composition as in claim 1 wherein the composition comprises less than 1 weight percent water.

5. A composition as in claim 2 wherein the composition additionally comprises a fatty acid.

6. A composition as in claim 2 wherein the composition additionally comprises a liquid polymer.

7. A composition as in claim 1 wherein the composition additionally comprises one or more pigments, dyes, biocides or fire retardants.

8. A composition as in claim 7 wherein the biocides is selected from the group consisting of azoles, quaternary ammonium compounds, borate compounds, fluoride compounds and copper compounds.

9. A composition as in claim 7 wherein the fire retardant is selected from the group consisting of phosphorus compounds, boron compounds, metal carbonates, metal hydroxides, organic halogen compounds, antimony compounds, and urea.

10. A composition as in claim 1 wherein the pigment is an ultraviolet stabilizer.

11. A composition as in claim 7 wherein the biocide is copper 8-hydroxyquinoline.

12. A composition as in claim 1 wherein the oil is a drying oil.

13. A composition as in claim 1 wherein the oil is selected from the group consisting of linseed oil, tung oil, castor oil, soybean oil, corn oil, olive oil, peanut oil, rapeseed oil, safflower oil, cotton seed oil, sunflower oil, sesame seed oil, rice germ oil, palm oil, coconut oil, fish oil, whale oil and tall oil.

14. A composition as in claim 1 wherein the oil is mineral oil.

15. A composition as in claim 1 wherein the wax is a petroleum wax, natural wax, or synthetic wax.

16. A composition as in claim 1 wherein the wax is selected from the group consisting of paraffin wax, microcrystalline wax, slack wax and scale wax, carnauba wax, bees wax, montan wax, candelilla wax, ouricury wax, rice-bran wax, bayberry wax, peat wax, ceresin wax, Japan wax, Nopco wax, spermacetic wax, polymethylene waxes, polyethylene waxes, polymerized α-olefin waxes.

17. A composition as in claim 1 wherein the wax has a melting point, ASTM D-87, in the range of from 38° C. to 120° C.

18. A composition as in claim 16 wherein the wax is a paraffin wax having a melting point in the range of from 45° C. to 75° C. and an average molecular weight in the range of from 350-420.

19. A composition as in claim 16 wherein the wax is an α-olefin wax having a melting point in the range of from about 54° C. to 80° C. and an average molecular weight in the range of from about 2600 to 2800.

20. A composition as in claim 1 wherein the weight ratio of wax to oil is in the range of from about 100:0.1 to 0.1:100.

21. A composition as in claim 1 wherein the weight ratio of wax to oil is in the range of from about 10:1 to 1:10.

22. A composition as in claim 1 wherein the weight ratio of wax to oil is in the range of from about 2:1 to 1:2.

23. A composition as in claim 5 wherein the fatty acid is stearic acid in a weight % in the range of from about 0.1 to 35.

24. A composition as in claim 5 wherein the fatty acid is stearic acid in a weight % in the range of from about 15 to 30.

25. A composition as in claim 6 wherein the liquid polymer is polybutene in a weight % in the range of from about 0.1 to 35.

26. A composition as in claim 6 wherein the liquid polymer is polybutene in a weight % in the range of from about 15 to 30.

27. A composition as in claim 1 wherein the composition is capable of providing to wood an ASE and WEE greater than 50 percent and 50 percent, respectively when said wood is tested for Water Repellency according to AWPA Standard E4-03.

28. A composition as in claim 1 wherein the composition is capable of providing to wood an ASE and WEE greater than 90 percent and 90 percent, respectively when said wood is tested for Water Repellency according to AWPA Standard E4-03.

29. A process for increasing the dimensional stability of wood, said process comprising the steps of:
a) providing a wood or wood product substrate;
b) preparing a composition comprising
1) a wax;
2) an oil;
c) applying the composition to the wood or wood product substrate, wherein the composition comprises less than 25 weight percent water.

30. A process as in claim 29 wherein the composition completely penetrates the sapwood.

31. A process as in claim 29 wherein the composition is applies to the wood or wood product by impregnation.

32. A process as in claim 29 wherein a composition comprising a fatty acid is applied to the wood.

33. A process as in claim 29 wherein a composition additionally comprising a liquid polymer is applied to the wood.

34. A process as in claim 29 wherein the composition is applied to the wood or wood product at a temperature in the range of from 30° C. to 220° C.

35. Wood through which is distributed a composition comprising a wax and an oil and has an ASE and WEE of greater than about 50% when tested for Water Repellency according to AWPA Standard E4-03.

36. Wood through which is distributed a composition comprising a wax and an oil and is substantially dimensionally stable.

37. Wood as in claim 34 which is capable of exposure to outdoor conditions for time periods as long as 6 months while remaining substantially dimensionally stable.
